(19) United States
(12) Patent Application Publication
(10) Pub. No.: US 2016/0160957 A1
(43) Pub. Date: Jun. 9, 2016

(54) Rotary Vibration Damping Arrangement For The Drivetrain Of A Motor Vehicle

(71) Applicant: ZF FRIEDRICHSHAFEN AG, Friedrichshafen (DE)

(72) Inventors: Tobias DIECKHOFF, Würzburg (DE); Thomas DÖGEL, Nüdlingen (DE)

(21) Appl. No.: 14/907,522

(22) PCT Filed: Jun. 23, 2014
(86) PCT No.: PCT/EP2014/063128

§ 371 Date: Jan. 25, 2016

(30) Foreign Application Priority Data
Jul. 23, 2013 (DE) 10 2013 214 352.4

(51) Int. Cl. F16F 15/12; F16F 15/14; F16F 15/131; F16H 1/28; F16H 45/02

(52) U.S. Cl. CPC F16F 15/1206; F16H 1/28; F16H 45/02; F16F 15/13157; F16F 15/145; F16H 2045/0268

(57) ABSTRACT

A torsional vibration damping arrangement for the drivetrain of a motor vehicle having an input region driven in rotation around a first rotational axis (A) and an output region; a first torque transmission path proceeding from the input region to the output region; a second torque transmission path proceeding from the input region to the output region; and a coupling arrangement connected to the output region for superposing the torques guided via the torque transmission paths. The coupling arrangement includes a planetary gear set with a planet gear rotatable around a second rotational axis (B). The first rotational axis (A) and the second rotational axis (B) run obliquely with respect to one another.

### CROSS REFERENCE TO RELATED APPLICATIONS

This is a U.S. national stage of application No. PCT/EP2014/063128, filed on Jun. 23, 2014. Priority is claimed on German Application No.: DE102013214352.4, filed Jul. 23, 2013, the content of which is incorporated herein by reference.

### BACKGROUND OF THE INVENTION

1. Field of the Invention

The present invention is directed to a torsional vibration damping arrangement for the drivetrain of a vehicle, comprising an input region driven in rotation around a first rotational axis, an output region, a first torque transmission path extending from the input region to the output region, a second torque transmission path extending from the input region to the output region, and a coupling arrangement for superposing torques guided via the torque transmission paths, this coupling arrangement being connected to the output region, wherein the coupling arrangement comprises a planetary gear set with a planet gear that is rotatable around a second rotational axis.

2. Detailed Description of Prior Art

An assembly in the form of a torsional vibration damping arrangement known from German Patent Application DE 10 2011 007 118 A1 divides a torque introduced into an input region through a crankshaft of a drive unit, into a torque component guided via a first torque transmission path and a torque component guided via a second torque transmission path. Not only is there a static torque divided in this torque division, but the vibrations or rotational irregularities contained in the torque to be transmitted, which are generated, for example, by periodically occurring ignitions in a drive unit, are also divided proportionately into the two torque transmission paths. The torque components transmitted via the two torque transmission paths are brought together again in a coupling arrangement or superposition arrangement constructed as a planetary gear set with a planet gear carrier and are then introduced as a total torque into an output region, for example, a friction clutch, a transmission, or the like.

A phase shifter arrangement having an input element and an output element is provided in at least one of the torque transmission paths. This phase shifter arrangement is constructed in the manner of a vibration damper, i.e., with a primary side and a secondary side that is rotatable with respect to the primary side through a compressibility of a spring arrangement. In particular when this vibration system passes into a supercritical state, i.e., when it is excited with vibrations exceeding a resonant frequency of the vibration system, a phase shift of up to 180° can occur. This means that at maximum phase displacement the vibration components proceeding from the vibration system are shifted in phase by 180° with respect to the vibration components received by the vibration system. Since the vibration components guided via the other torque transmission path do not undergo a phase shift or, if so, a different phase shift, the vibration components, which are contained in the torque components brought together by the coupling arrangement and which are then shifted in phase with respect to one another, are destructively superposed on one another such that, ideally, the total torque introduced into the output region is a static torque which contains essentially no vibration components.

A torsional vibration damping arrangement 10 that operates on the principle of power splitting or torque splitting is shown schematically in FIG. 1. The torsional vibration damping arrangement 10 can be arranged in a drivetrain of a vehicle between a drive unit 12 and a subsequent portion of the drivetrain, i.e., for example, a start-up element 14 such as a friction clutch, a hydrodynamic torque converter, or the like. The torsional vibration damping arrangement 10 comprises an input region, designated generally by 16. In the input region 16, a torque received from the drive unit 12 branches into a first torque transmission path 18-1 and a second torque transmission path 18-2. In the region of a superposition unit, also referred to hereinafter as coupling arrangement, which is designated generally by reference numeral 20, the torque components that are guided via the two torque transmission paths 18-1, 18-2 are introduced into the coupling arrangement 20 by a first coupling arrangement input part 22 which can comprise a planet gear carrier or ring gear carrier 24 and by a second coupling arrangement input part 26 which can have an input sun gear 28, and the torque components are combined again in the coupling arrangement 20. It is also possible for the coupling arrangement input parts and coupling arrangement output parts to be constructed differently. For example, the coupling arrangement 20 can be constructed as a planetary gear set 30. For example, a first planet gear 32 and a second planet gear 34 can be rotatably mounted at the planet gear carrier 22 radially successively so as to overlap axially. The first planet gear 32 can mesh with the input sun gear 28 on the one hand and with the second planet gear 34 on the other hand. In the merely exemplary arrangement shown in FIG. 1, the second planet gear 34 serves to reverse the rotational direction. The combined torque is guided from the second planet gear 34 to the start-up element 14, e.g., a clutch or a transmission, via an output part 36 which can comprise, e.g., an output ring gear 38 which likewise meshes with the second planet gear 34 and which is connected to an output region 40 so as to be fixed with respect to rotation relative to it.

A vibration system, designated generally by reference numeral 42, is integrated in the first torque transmission path 18-1. The vibration system 42 acts as a phase shifter arrangement and comprises a primary mass 44 connected, for example, to the drive unit 12, an input element 46 connected to the primary mass 44 so as to be fixed with respect to rotation relative to it, and a spring arrangement 48 connected to the input element 46. An output element 50 of the spring arrangement 48 is further connected to an intermediate element 52 which in this instance forms the planet gear carrier 24, for example, and is rotatably mounted at the first planet gear 32 and second planet gear 34. Accordingly, in the torsional vibration damping arrangement 10 according to FIG. 1 the planet gear carrier 24 is positioned, for example, in the first torque transmission path 18-1, in which the torsional irregularities guided via the first torque transmission path 18-1 are phase-shifted with respect to the torsional irregularities guided via the second torque transmission path 18-2. Due to the fact that the output element 50 of the spring arrangement 48 is connected to the planet gear carrier 24 so as to be fixed with respect to rotation relative to it, the phase shifter arrangement 42 and coupling arrangement 20 form a unit which is compact in axial extension. It is also positive for decoupling quality that mass moments of inertia of the planet gear carrier 24 and of the first planet gear 32 and second planet gear 34 are included in the mass inertia of the intermediate element 52.

A torque flow in the first torque transmission path 18-1 can run from the drive unit 12 via the primary mass 44 and input element 46 into the spring arrangement 48. The first torque is guided from the spring arrangement 48 via the output element 50 of spring arrangement 48 and intermediate element 52 to the planet gear carrier 24, which receives primarily the first planet gear 32 and second planet gear 34. The output element 50, intermediate element 52 and planet gear carrier 24 are connected to one another so as to be fixed with respect to rotation relative to one another.

In the second torque transmission path 18-2, the second torque is guided from the drive unit 12 into an input sun gear 28 connected to the latter so as to be fixed with respect to rotation relative to it. The input sun gear 28 meshes with the first planet gear 32 and accordingly guides the second torque to the first planet gear 32 of the coupling arrangement 20.

Consequently, the first torque and second torque arrive via the two torque transmission paths 18-1 and 18-2 at the first planet gear 32, where they are guided together again. The second planet gear 34, which meshingly engages with the first planet gear 32, serves to reverse the rotational direction before the combined torque is guided from the first planet gear 34 via the output ring gear 38 to the output region 40, to which is fastened the start-up element 14, for example, a friction clutch, a transmission or a torque converter, not shown here.

In case the mass inertia of the intermediate element 52 is not sufficient for achieving a decoupling quality, an additional mass element 54 can be fastened to the intermediate element 52 so as to be fixed with respect to rotation relative to it. An additional improvement in decoupling can be achieved by positioning a known pendulum mass 56 at the intermediate element 52.

Torsional vibration damping arrangements 10 of this type can be connected in addition to hydrodynamic torque converters between a converter lockup clutch and an output unit, e.g., a transmission drive shaft. Further, the converter lockup clutch, torsional vibration damping arrangement and hydrodynamic torque converter can be located in a shared housing, i.e., inside a transmission bell housing. While engine torques to be transmitted are constantly increasing, there is less and less available installation space in the transmission bell housing.

FIG. 2a shows a torsional vibration damping arrangement 10′ on the same principle as that described referring to FIG. 1, as an application in connection with a hydrodynamic torque converter 90 as start-up element. The resulting start-up element primarily comprises the torque converter 90 with a converter lockup clutch 62 and the torsional vibration damping arrangement 10′ which is arranged between the converter lockup clutch 62 and an output unit, e.g., a transmission input shaft. The torsional vibration damping arrangement 10′ comprises, as has already been described referring to FIG. 1, a first torque transmission path 18-1 and second torque transmission path 18-2, a phase shifter arrangement 42 and a coupling arrangement 20 in the form of a planetary gear set. To better illustrate the working principle of the start-up element shown in FIG. 2a, FIG. 2b shows a torque path with closed converter clutch 62, while FIG. 2c shows a torque path with open converter clutch 62. FIGS. 2b and 2c are to be viewed with reference to the descriptions of FIG. 2a.

In a closed converter clutch 62 with the torque path shown in FIG. 2b, a total torque Mg which can come from a drive unit 12 an internal combustion engine, arrives at a converter housing 95 via a crankshaft 19. Further, the total torque Mg is guided from the converter housing 95 into the converter lockup clutch 62 via a converter clutch drive 63. Due to a closed converter lockup clutch 62 referring to FIG. 2b, the total torque Mg is guided further via a converter clutch output 64 into the torsional vibration damping arrangement 10′, in this case at a guide plate 59 of a radially inner spring set or inner spring set 58 connected to the converter clutch output 64 so as to be fixed with respect to rotation relative to it. Accordingly, the guide plate 59 can also be viewed as an input region 16 of the torsional vibration damping arrangement 10′. From the guide plate 59, the total torque Mg is divided into a first torque Mg1 and a second torque Mg2. The first torque Mg1 passes from the guide plate 59 to an inner spring set 58. The first torque Mg1 is guided from the inner spring set 58 via a hub disk 61 to an outer spring set 57 which is arranged inside the converter housing 95 farther radially outward than the inner spring set 58. From the outer spring set 57, the first torque Mg1 passes via a stop element 65 and an intermediate element 52, constructed in this instance as an input ring gear carrier of the planetary gear set or coupling arrangement 20 and connected to the stop element 65 so as to be fixed with respect to rotation relative to it, to an input ring gear 68 which is in turn connected to the input ring gear carrier 52 so as to be fixed with respect to rotation relative to it and is rotatable around an axis A. The input ring gear 68 meshes with a first toothing segment 81-1 of a planet gear 34 and accordingly guides the first torque Mg1 to the planet gear 34.

The second torque Mg2 passes via the guide plate 59 to an input sun gear carrier 17 connected to the guide plate 59 so as to be fixed with respect to rotation relative to it. An input sun gear 28 is connected to the input sun gear carrier 17 so as to be fixed with respect to rotation relative to it. The input sun gear carrier 17 and the input sun gear 28 can also be produced as one structural component part. Consequently, the second torque Mg2 is guided to the input sun gear 28. The input sun gear 28 meshes with a second toothing segment 81-2 of the planet gear 34 and accordingly guides the second torque Mg2 to the planet gear 34. Accordingly, the first torque Mg1 and the second torque Mg2 are guided together again at the planet gear 34. In so doing, a vibration component in the first torque Mg1 which is guided via the first torque transmission path 18-1 through the phase shifter arrangement 42 is phase-shifted by the phase shift ideally by 180° relative to the vibration component in the second torque Mg2 which is not guided via the phase shifter arrangement 42. Consequently, the first torque Mg1 with a vibration component that is phase-shifted by 180° and the second torque Mg2 would ideally be destructively superposed at the planet gear 34 such that the total torque Mg is present without torsional vibration components at a planet gear carrier 24 which is on the output side in this instance. In this case, the planet gear carrier 24 can also be viewed as output region 40 of the torsional vibration damping arrangement 10′. Referring to FIGS. 2a, b, c, the planet gear carrier 24 is connected to an output flange 86 so as to be fixed with respect to rotation relative to it. A transmission input shaft, not shown, can be connected in turn to the output flange 86 so as to be fixed with respect to rotation relative to it, and the total torque M can be guided further, ideally without vibration components, to a transmission, not shown.

To increase a mass moment of inertia of the intermediate element or of the input ring gear carrier 52, which can have positive results on phase shifting, a turbine 75 is non-rotationally coupled to the intermediate element or input ring gear carrier 52 via a support 71 which is riveted to the intermediate element 52 and therefore connected to the intermediate element 52 so as to be fixed with respect to rotation relative to it. In addition, additional masses 76 which are coupled to the support 71 can be provided. These additional masses 76 increase the mass moment of inertia of the intermediate element 52 or of the secondary side of the phase shifter 42 and can accordingly have a positive effect on the phase shifting. The turbine 75 of the torque converter 90 also forms a connection to an axial bearing location 72 in this case. Referring to the view in FIGS. 2a, b, c, an additional axial bearing 72 is inserted between a pressure disk 77 and the output flange 86 so that a bearing disk 78 which is connected to the turbine 75 so as to be fixed with respect to rotation relative to it is additionally guided axially between rolling elements of the bearing 72. This ensures not only an axial bearing support of a stator 66 which is connected to the pressure disk 77 so as to be fixed with respect to rotation relative to it, but also additionally ensures a bearing support of the turbine 75 and of the structural component parts fastened to the latter relative to the output flange 86 and relative to a freewheel 91 of stator 66 and the converter housing 95. A plain bearing or a rolling element bearing constructed in a different manner is also possible as axial bearing 72. However, the axial bearing location 72 should substantially absorb the axial forces of the turbine 75 in converter mode and should define the axial position of the intermediate element or input ring gear carrier 52. A radial bearing support of the coupling arrangement 20, 30 is carried out in the present instance via the toothing segments 81-1, 81-2 of the planet gear 34 as a so-called floating bearing.

A possibility which allows a stationary gear ratio required for the function of the torsional vibration damping arrangement 10′ to be realized between the input sun gear 28 and the output ring gear 68 with a smaller radial installation space requirement than that shown in FIG. 1 is to use the planet gear 34 with two different toothing segments 81-1 and 81-2 as is shown in FIG. 2a. A center axis B forms a rotational axis and center axis for both toothing segments 81-1 and 81-2. Further, the two toothing segments 81-1 and 81-2 can partially overlap axially (i.e., in direction of rotational axis A or B) so that toothing segments 81-1 and 81-2 are formed in each instance with 180 angular degrees. The use of the planet gear 34 with two different partially axially overlapping toothing segments 81-1 and 81-2 is possible because a twist angle around rotational axis B of the planet gear 34 is sufficiently small. Due to the fact that the toothing segment 81-2 meshing with the input sun gear 28 is greater than the toothing segment 81-1 meshing with the input ring gear 68, the amount of the stationary gear ratio increases compared to a transmission with known planet gears with identical measurements and dimensions. Further, to make better use of the axial installation space, the two toothing segments 81-1 and 81-2 of the planet gear 34 can be partially axially offset relative to one another as is shown.

With an open converter clutch 62 with the torque path shown in FIG. 2c, a total torque Mo is guided via the converter housing 95 and a connection plate 67 and further to an impeller 74 of the torque converter 90. The impeller 74 is connected to the connection plate 67, for example by a weld joint, so as to be fixed with respect to rotation relative to it. The connection plate 67 is in turn connected to the converter housing 95, for example by a weld joint, so as to be fixed with respect to rotation relative to it. Accordingly, at the torque converter 90 the total torque Mo is present at the impeller 74. Depending on a configuration of the torque converter 90 and of the applied total torque Mo and an applied rotational speed at the impeller 74, a torque Mt is present at the turbine 75. Since the turbine 75 is coupled to the input ring gear carrier or intermediate element 52 so as to be fixed with respect to rotation relative to it, torque Mt is guided further from the turbine 75 to the intermediate element 52. From the intermediate element 52, torque Mt is split into two torque components Mt1 and Mt2. The one torque component Mt2 is present at the input ring gear 68 which is coupled to the intermediate element 52 so as to be fixed with respect to rotation relative to it. The other torque component Mt1 is guided via the intermediate element 52 and the stop element 65 to the outer spring set 57. This torque component Mt1 passes from the outer spring set 57 via the hub disk 61 to the inner spring set 58 and further from the inner spring set 58 via the guide plate 59 to the input sun gear carrier 17 and, consequently, to the input sun gear 28. Since the input sun gear 28 and the input ring gear 68 mesh with the planet gear 34, the two torque components Mt1 and Mt2 are guided together again at the planet gear 34. Via the output-side planet gear carrier 24 at which the planet gear 34 is rotatably supported, the combined torque Mt is guided onward to the output flange 86 which is connected to the planet gear carrier 24, for example by a weld joint, so as to be fixed with respect to rotation relative to it. It is also possible to construct the output-side output flange 86 and planet gear carrier 24 as one output-side component part. The combined torque Mt can be guided from the output-side output flange 86 to a transmission, not shown, or the like structural component part.

As can be seen from FIG. 2a, the part 81-2 of planet gear 34 that meshes with the sun gear 28 cannot make use of the space, designated by reference numeral 80, radially inside of the inner spring set 58 and associated cover plate when its rotational axis B runs parallel to rotational axis A of the converter 90, as is shown, and when the swiveling area of the planet 34 exceeds a determined angle because otherwise there would be a collision with the torsional damper 10′. This conflicts with the demand for increasingly smaller installation space.

### SUMMARY OF THE INVENTION

It is an object of the present invention to develop a torsional vibration damping arrangement such that it is improved over known torsional vibration damping arrangements and in particular has a more compact (axial) installation space.

According to one embodiment of a torsional vibration damping arrangement for a drivetrain of a motor vehicle comprises an input region to be driven in rotation around a first rotational axis and an output region. The torsional vibration damping arrangement further comprises a first torque transmission path running from the input region to the output region and a second torque transmission path running from the input region to the output region. The two torque transmission paths form a power split for a total torque that is to be transmitted in all via the torsional vibration damping arrangement. The torsional vibration damping arrangement further has a coupling arrangement which is connected or coupled to the output region for superposing torques conducted via the two torque transmission paths. The coupling arrangement according to embodiment examples comprises a planetary gear set with at least one planet gear which is rotatable around a second rotational axis. According to embodiment examples, the first rotational axis and the second rotational axis run obliquely with respect to one another, i.e., not parallel to one another.

According to one embodiment, it is suggested to tilt the second rotational axis of the planet gear of the coupling arrangement relative to the first rotational axis of the transmission. In particular, the second rotational axis can be tilted in such a way relative to the first rotational axis that better use can be made of an installation space radially inside of the above-described inner spring set of the torsional vibration damping arrangement and of the associated cover plate or guide plate. By corresponding inclination or tilting, the radially inner sun gear on its sun gear carrier can be installed axially closer to the inner spring set or its guide plates so that the torsional vibration damping arrangement and particularly the start-up elements comprising the torsional vibration damping arrangement can be constructed so as to be axially narrower. Accordingly, embodiment examples make it possible to follow the trend toward increasingly smaller installation spaces in the transmission housing.

According to embodiment examples, the first rotational axis and second rotational axis are tilted with respect to one another such that the first rotational axis and second rotational axis run obliquely with respect to one another in a plane defined by the two rotational axes. Proceeding from an axial direction which is defined by the first rotational axis, the second rotational axis has, in addition to an axial component parallel to the first rotational axis, an additional directional component which is oriented perpendicular to the axial direction defined by the first rotational axis. This can be a radial component, for example. Depending on specific constructional requirements, an angle between the two rotational axes can be in a range from 0° to 45°, particularly from 5° to 20°. According to one embodiment, an inclination or tilting of the two rotational axes with respect to one another is selected in such a way that a radially inwardly located portion of the planet gear or a sun gear meshingly engaging therewith can move closer together axially with the input region or an (inner) spring set of the torsional vibration damping arrangement.

At the same time, a rotational axis of an input ring gear of the planetary gear set which is located in the first torque transmission path and which meshes with the planet gear and a rotational axis of a sun gear of the planetary gear set which is located in the second torque transmission path and which meshes with the planet gear can each run parallel to the first rotational axis. In other words, only the rotational axis of the planet gear can be tilted relative to the first rotational axis, whereas rotational axes of further elements of the planetary gear set such as, for example, the input sun gear, input ring gear and/or an output ring gear, run substantially parallel to the first rotational axis. In a particularly advantageous manner, this makes it possible to economize on axial installation space while deviating only slightly from proven construction principles.

According to one embodiment, the planet gear can have a first planet gear part with a first toothing diameter and a second planet gear part with a second toothing diameter which differs from the first toothing diameter. Whereas, in one embodiment the first planet gear part and second planet gear part can be realized by different planet gears arranged coaxially along the second rotational axis and have different toothing diameters, there are also preferred embodiment examples in which the first planet gear part is formed by a first circle segment of the planet gear with the first toothing diameter and the second planet gear part is formed by a second circle segment of the planet gear with the second toothing diameter. In particular, the latter embodiment forms make it possible to gain significant axial installation space in an efficient manner. Due to the different toothing diameters of the first planet gear part and second planet gear part, transmission ratios between the first torque transmission path and second torque transmission path can be variably configured, which can have advantageous results for the design of the torsional vibration damping arrangement overall and can offer an advantage with respect to installation space.

According to one embodiment, an input ring gear of the planetary gear set located in the first torque transmission path meshingly engages with the first planet gear part, and a sun gear of the planetary gear set located in the second torque transmission path meshingly engages with the second planet gear part. In order to be able to arrange the input ring gear on one hand and the sun gear of the planetary gear set on the other hand in different axial planes in accordance with installation space, the two planet gear parts can be arranged so as to be axially offset with respect to one another in direction of the first rotational axis and/or the second rotational axis (i.e., in the respective axial direction). Of course, embodiment forms in which the two planet gear parts are arranged in the same axial plane in axial direction, i.e., in direction along the first rotational axis and/or second rotational axis, are also conceivable. Embodiment forms of this kind make it possible in particular to fabricate the planetary gear set in a simple and inexpensive manner.

According to one embodiment, the first torque transmission path includes a phase shifter arrangement for generating a phase shift of rotational irregularities guided via the first torque transmission path with respect to rotational irregularities guided via the second torque transmission path. Accordingly, a phase shifter arrangement with an input element and an output element can be provided in at least one of the torque transmission paths. This phase shifter arrangement can be constructed in the manner of a vibration damper, i.e., with a primary side and a secondary side which is rotatable with respect to the primary side through the compressibility of a spring arrangement. In particular, when this vibration system passes into a supercritical state, i.e., when it is excited with vibrations exceeding the resonant frequency of the vibration system, a phase shift of up to 180° can occur between the two torque transmission paths. This means that at maximum phase displacement the vibration components proceeding from the vibration system are shifted in phase by 180° with respect to the vibration components received by the vibration system. Since the vibration components conducted via the other torque transmission path do not undergo a phase shift or, if so, a different phase shift, the vibration components which are contained in the unified torque components and which are then shifted in phase with respect to one another are destructively superposed on one another such that, ideally, the total torque introduced into the output region is a static torque which contains essentially no vibration components. The spring arrangement of the phase shifter arrangement can have at least one spring set which advantageously comprises a coil spring. When at least two spring sets are used, they can be arranged so as to act in parallel as well as in series.

To bring about further improvements with respect to a required axial installation space, a secondary side of the phase shifter arrangement which is coupled with the primary side of the latter via a spring arrangement can be formed substantially by a one-piece mass base body for providing a required mass moment of inertia. Compared to conventional multiple-part or multiple-piece masses and/or additional masses for providing the required mass moment of inertia, a one-piece mass base body offers advantages particularly with respect to installation space. To save even more axial and/or radial installation space, some embodiment examples suggest incorporating a ring gear toothing in the secondary-side one-piece mass base body for meshing with the planet gear. In embodiment forms of this type, the one-piece mass base body can serve simultaneously as input ring gear for introducing a torque that is guided via the first torque transmission path into the planet gear in which the two torque transmission paths are guided together before they are conveyed onward via an output-side planet carrier or ring gear carrier to a torque output of the torsional vibration damping arrangement.

To further optimize installation space, the integrally formed mass base body can be used further as radial support for the (outer) spring set of the phase shifter arrangement so as to economize on conventional component parts such as, e.g., guide plates and stop elements for the spring arrangement. In addition or alternatively, the mass base body can also have studs which protrude into a spring channel and can function as stops for a spring of the spring arrangement in circumferential direction (i.e., tangential to the first rotational axis). In this way, further component parts and, therefore, ultimately also further installation space can be saved.

Further potential saving of installation space, particularly in axial direction, can be achieved in that a hub disk of a primary side of an (outer) torsional vibration damper or spring set engages in the spring set from the radially inner side to the radially outer side. Compared to conventional constructions, this step allows the torsional vibration damping arrangement to be built in an axially narrower manner.

According to one embodiment, the torsional vibration damping arrangement can be coupled to a start-up element, e.g., a torque converter. In so doing, the torsional vibration damping arrangement can be connected between a converter lockup clutch and the start-up element or hydrodynamic torque converter. In this respect, some embodiment examples provide that the torque converter is arranged axially outside of or adjacent to the torsional vibration damping arrangement and that the torsional vibration damping arrangement is coupled to a turbine of the torque converter (so as to be fixed with respect to rotation relative to it) which further has a stator with a freewheel having a radial bearing, wherein an axial bearing support of the freewheel by which the freewheel is axially supported against the torsional vibration damping arrangement is arranged radially outside of the radial bearing of the freewheel. Compared to conventional constructional types such as were described by way of example referring to FIG. 2a, relocating the axial bearing from a position axially adjacent to the freewheel to a position radially above or outside of the freewheel brings about a further gain in axial installation space.

For optimal functioning, a power split provided by embodiment examples requires an efficient phase shifter and the power splitting gear unit. As a rule, these two components are arranged axially adjacent to one another because nesting in the same axial installation space is impossible especially when two-rowed spring accumulators are used as phase shifters. In this case, compared to other vibration-reducing systems, for example, a speed-adaptive mass damper which also requires installation space generally axially adjacent to the spring accumulator for a damper mass, the axial installation space is also needed especially in the inner radial region, i.e., in the region of the shaft, in order to allow the linking of planet carrier and sun gear or output ring gear depending on set-up. Further, the secondary side of the phase shifter with the associated component parts, e.g., input ring gear, possibly additional mass, and turbine, should also be supported, which is generally also carried out in this installation space area. However, it is precisely the new constructions of torque converter which are characterized by axial installation spaces in the region of the shaft which are small compared to the installation space farther radially outside, since space has been created on the radially outer side for components of a speed-adaptive mass damper, for example, through the use of an oval-shaped hydrodynamic circuit. According to embodiment examples, this set of problems can be substantially mitigated in that the axial bearing location between an output flange to the transmission input shaft and a freewheel or stator of the torque converter, in which the bearing support of the secondary side of the phase shifter can also be integrated, is shifted from its former position axially adjacent to the freewheel to a larger radius radially outside of the freewheel and so as to be axially nested relative to the latter.

According to a further aspect, further embodiment examples also provide a motor vehicle with a torsional vibration damping arrangement according to embodiment examples.

### BRIEF DESCRIPTION OF THE DRAWINGS

Some exemplary embodiment examples will be described more fully in the following with reference to the accompanying drawings.

FIG. 1 is a schematic diagram showing a torsional vibration damping arrangement with two planet gears supported at the output of a phase shifter arrangement;

FIG. 2a is a torsional vibration damping arrangement applied in connection with a hydrodynamic torque converter;

FIG. 2b is a torque path of the arrangement according to FIG. 2a with closed converter clutch;

FIG. 2c is a torque path of the arrangement according to FIG. 2a with opened converter clutch;

FIG. 3 is a section through a torsional vibration damping arrangement;

FIGS. 4a, b is a sectional view of a segmented planet gear with two different toothing diameters;

FIG. 5 is a start-up element with a torsional vibration damping arrangement which is arranged between a converter lockup clutch and a torque converter;

FIG. 6 is a start-up element with a torsional vibration damping arrangement;

FIG. 7 is a start-up element with a torsional vibration damping arrangement with a one-piece mass base body for providing a mass moment of inertia;

FIG. 8 is a start-up element with a torsional vibration damping arrangement with a hub disk which engages in a spring arrangement of a phase shifter arrangement from the radially inner side to the radially outer side;

FIGS. 9, 10 are further examples of start-up elements with a torsional vibration damping arrangement for obtaining additional axial installation space;

FIG. 11a is a torsional vibration damping arrangement with a torque converter, wherein an axial bearing support of a freewheel of a stator of the torque converter is arranged radially outside of the freewheel;

FIG. 11b is an axial bearing according to FIG. 11a;

FIG. 12 is a torsional vibration damping arrangement with a torque converter, in which an axial bearing support of a freewheel of a stator of the torque converter is arranged radially outside of the freewheel; and

FIG. 13 is an element between output region of a torsional vibration damping arrangement and an output region of a coupling arrangement, that limits a relative rotation between the first output region of the torsional vibration damping arrangement and the output region of the coupling arrangement around the rotational axis.

Various examples will now be described in more detail referring to the accompanying figures in which some examples are shown. The thickness of lines, layers and/or regions may be exaggerated for the sake of clarity.

In the following description of the accompanying drawings which merely show some exemplary embodiments, like reference numerals may designate like or comparable components. Further, summarizing reference numerals may be used for components and objects which occur several times in an embodiment example or in a drawing but which are collectively described with respect to one or several features. Components or objects designated by the same or summarizing reference numerals may be implemented alike but also differently with respect to individual features, several features or all features, such as, e.g., dimensioning, insofar as the context does not implicitly or explicitly indicate otherwise.

Although embodiment examples may be modified and altered in various ways, embodiment examples in the figures illustrate examples and are described in detail herein. However, it will be appreciated that there is no intention of limiting embodiment examples to the disclosed forms but, on the contrary, that embodiment examples are intended to cover all functional and/or structural modifications, equivalent arrangements and alternatives within the scope of the invention.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g. “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will further be understood that the terms “comprises”, “comprising”, “has” and/or “having” when used herein specify the presence of stated features, integers, steps, operations, elements and/or components, but do not preclude the presence or addition of one or more features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

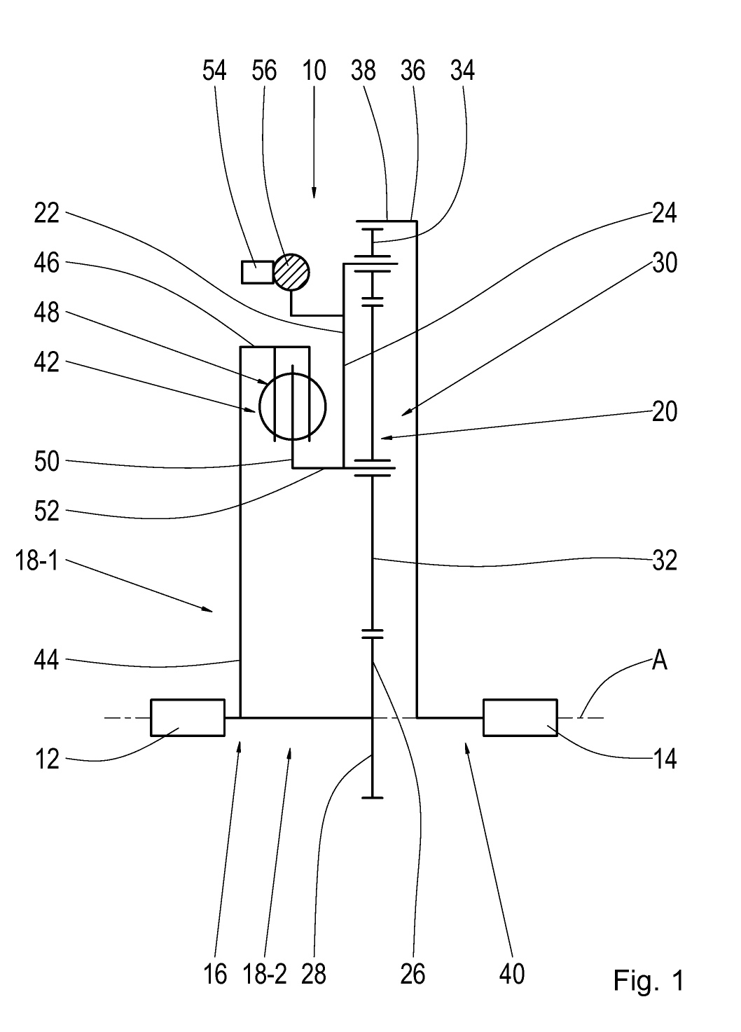

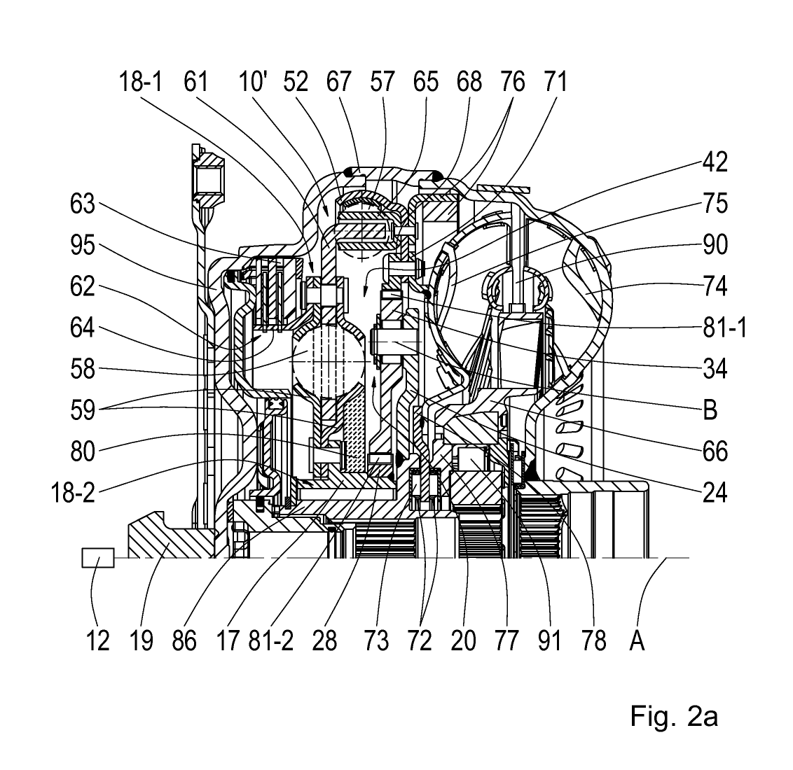

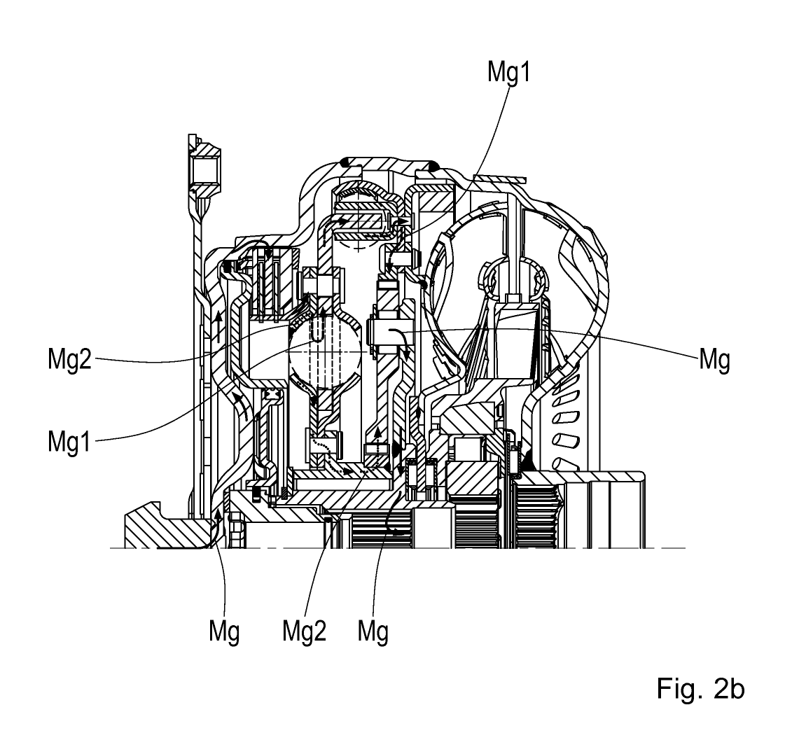

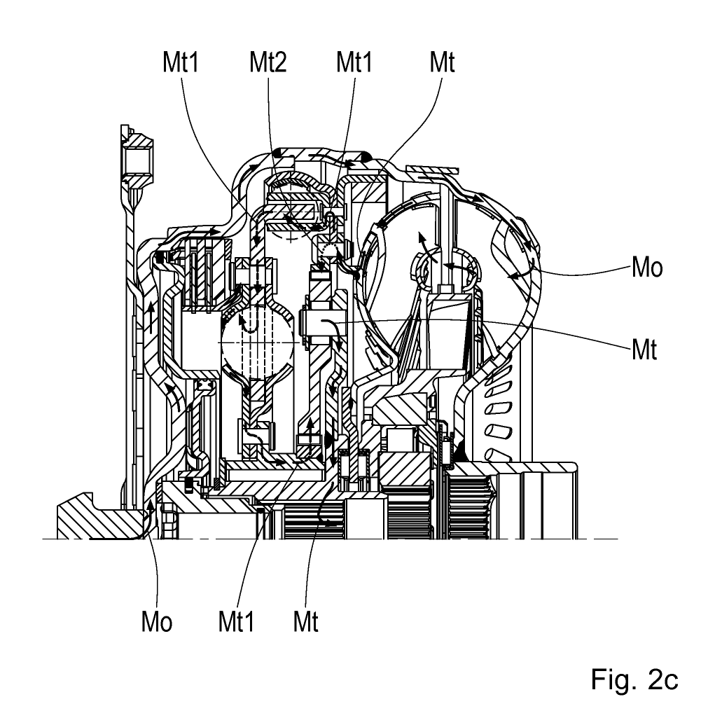

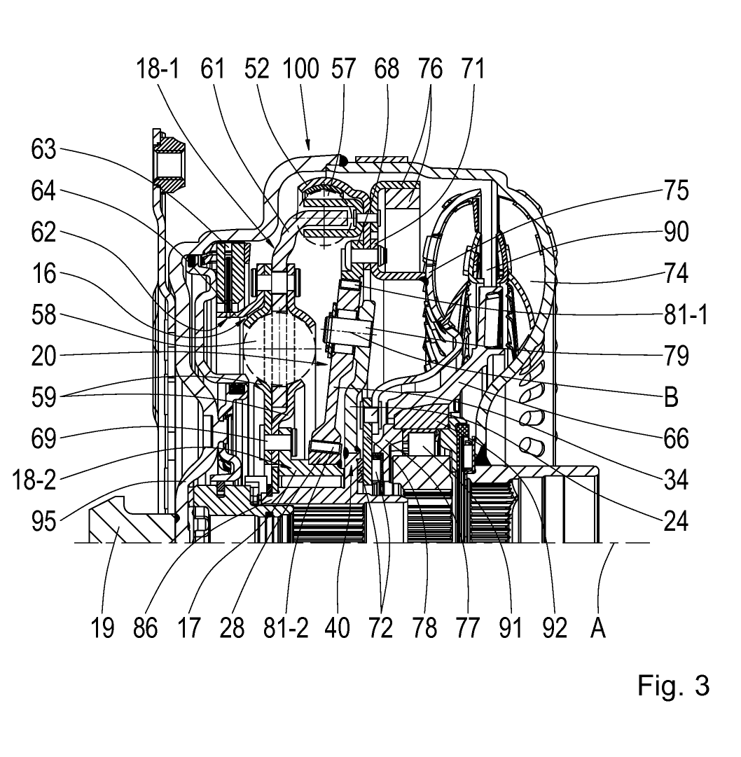

FIG. 3 shows a torsional vibration damping arrangement 100 which, by way of example, is integrated in a converter housing 95 together with a converter lockup clutch 62 and a hydrodynamic torque converter 90 and forms a start-up element. The torsional vibration damping arrangement 100 accordingly forms a subassembly of a drivetrain arranged axially next to or adjacent to the converter 90. An output 64 of the converter clutch 62 forms an input region 16 of the torsional vibration damping arrangement 100 which is to be driven, or can be driven, in rotation around a first rotational axis A. A planet gear carrier 24 which can be coupled, for example by a weld joint, to an output flange 86 to the transmission input shaft forms an output region 40 of the torsional vibration damping arrangement 100. As has already been described above referring to FIGS. 1 and 2, the torsional vibration damping arrangement 100 according to FIG. 3 also comprises a first torque transmission path 18-1 running from the input region 16 to the output region 40 and a second torque transmission path 18-2 running from the input region 16 to the output region 40 and therefore forms a power split. A coupling arrangement 20 for superposing torques guided via the two torque transmission paths 18-1, 18-2 is connected to the output region 40. According to one embodiment, the coupling arrangement 20 comprises a planetary gear set 30 with a planet gear 34 rotatable around a second rotational axis B arranged radially outside of the first rotational axis A which can be formed by a transmission input shaft, for example. The torsional vibration damping arrangement 100 according to FIG. 3 differs from the torsional vibration damping arrangement 10′ according to FIGS. 2a, b, c particularly in that the first rotational axis A and the second rotational axis B run obliquely with respect to one another. The functions are similar in other respects so that the manner of functioning need not be described again in detail. The reader is referred to the description of FIGS. 2a-c. The word “oblique” may be understood as meaning that the first rotational axis A and the second rotational axis B extend so as to be inclined or tilted with respect to one another in a plane defined by the two rotational axes A, B. Thus, according to one embodiment, the two rotational axes A, B can be arranged in such a way that they define a plane in common. This plane can have an axial component (in direction of the first rotational axis A) and a radial component (radially away from the first rotational axis A toward the second rotational axis B). The two rotational axes A, B can form an angle not equal to 0° in this common plane. In particular, the angle formed by the two rotational axes A, B can range from 0° to 45°, particularly from 5° to 20°.

As can further be seen referring to the embodiment example in FIG. 3, a rotational axis of an input ring gear 68 of the coupling arrangement 20, which input ring gear 68 is located in the first torque transmission path 18-1 and meshes with the inclined planet gear 34, can run parallel to the first rotational axis A. In like manner, a rotational axis of a sun gear 28 of the coupling arrangement 20, which sun gear 28 is arranged in the second torque transmission path 18-2 and meshes with the inclined planet gear 34, can also run parallel to the first rotational axis A. In one embodiment, the rotational axes of the input ring gear 68 and/or of the sun gear 28 can coincide with rotational axis A which can be formed, for example, by a transmission input shaft. Owing to the inclination of the planet gear 34, the sun gear 28 and input ring gear 68 can be located in different axially arranged planes, i.e., in different planes offset axially along rotational axis A. Compared to the arrangement described referring to FIGS. 2a-c, the sun gear 28 according to the arrangement in FIG. 3 is substantially closer in axial direction (i.e., in direction of rotational axis A) to the inner guide plates 59 of the inner torsional vibration damper 58 which extend in radial direction. In particular, the sun gear 28 can now be located in immediate axial vicinity of a connection bolt 69 between the inner-damper guide plates 59 and the bearing flange 17. Therefore, substantial axial installation space can be saved precisely in radial vicinity of the first rotational axis A.

Owing to the inclination of the planet gear 34 and the rotational axis B thereof, which can be defined by a bolt 79, an inner toothing of the input ring gear 68 and/or an outer toothing of the sun gear 28 can likewise be formed obliquely. In other words, this means that a plane formed by a pitch circle of the inner toothing of the input ring gear 68 and/or a pitch circle of the outer toothing of the sun gear 28 extends perpendicular to the second rotational axis B (and, therefore, obliquely with respect to rotational axis A) just like the pitch circle or pitch circles of the outer teeth of the planet gear 34.

As can be seen from FIG. 3, one embodiment provides a planet gear 34 that comprises a first planet gear part (above the second rotational axis B) with a first toothing diameter and a second planet gear part (below the second rotational axis B) with a second toothing diameter differing from the first toothing diameter. In contrast to the embodiment form shown here, it is also conceivable to have planet gears of different sizes which are arranged so as to be axially offset with respect to one another along the second rotational axis B, the larger of the planet gears meshingly engaging with the sun gear 28 and the smaller of the planet gears meshingly engaging with the input ring gear 68, for example. However, a preferred embodiment provides that the first planet gear part is formed by a first circle segment of the planet gear 34 having the first toothing diameter and the second planet gear part is formed by a second circle segment of the planet gear 34 having the second toothing diameter.

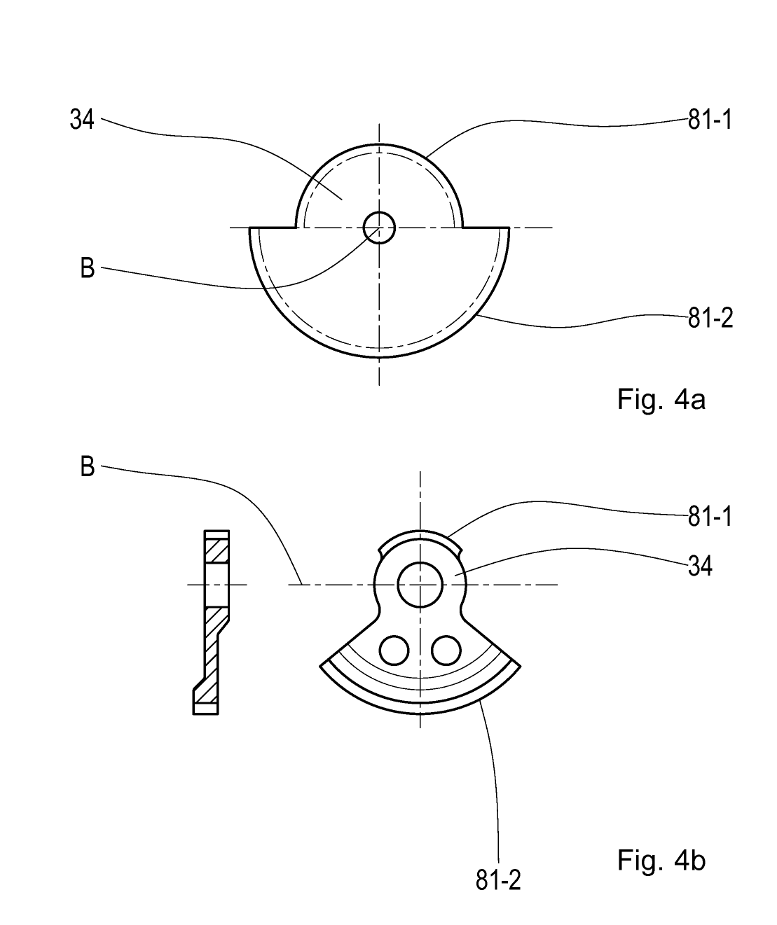

FIG. 4a shows a possible construction of the planet gear 34 with two different toothing segments 81-1 and 81-2 in a top view. The center axis or rotational axis B of the toothing segments 81-1 and 81-2 may be identical. In the present embodiment, the respective toothing (circle) segment 81-1 and 81-2 forms an angle of 180 degrees. However, toothing segments 81-1 and 81-2 can also form different angles, not shown; for example, toothing segment 81-1 can form an angle of 150 degrees and toothing segment 81-2 can form an angle of 210 degrees. The sum of the angular degrees of the toothing segments 81-1 and 81-2 can also be less than 360 angular degrees, but together make up a maximum of 360 angular degrees.

FIG. 4b shows a possible planet gear 34 with two different toothing segments 81-1 and 81-2 in section and in a top view. The two toothing segments 81-1 and 81-2 have the same center axis or rotational axis B. Toothing segment 81-1 can form an angle of approximately 90 degrees and toothing segment 81-2 can form an angle of approximately 100 degrees. The two toothing segments 81-1 and 81-2 can partially overlap in axial direction (along rotational axis B) (see FIG. 4b, left-hand side). It can be clearly seen that comparatively much mass and/or material can be saved when using toothing segments.

FIGS. 3 and 4 show how embodiment examples can save axial installation space in torsional vibration damping arrangements and start-up elements coupled therewith. In this regard, the rotational axis B of planet 34 of coupling arrangement 20 is tilted slightly relative to the rotational axis A of the gear unit. In this way, the installation space radially inside of the inner spring set 58 can be utilized partially for the sun gear 28 and the toothing segment 81-2 of planet 34 corresponding to the sun gear 28. This allows a greater width of the teeth.

In the constructional embodiments of the power split in the torque converter which have been presented thus far, the functional elements on the secondary side of the phase shifter 42, i.e., cover plate 52 of spring set 57, ring gear 68 and additional mass 76, have been considered as separate component parts which were connected to one another directly or via connection plates by a joining process, e.g., riveting. When bent sheet metal parts are used, free spaces result between the parts due to the bending radii and other shaping limitations. This is disadvantageous when mass is to be utilized in the most efficient possible manner for mass moment of inertia, since this means filling the installation space with material as tightly as possible on the far radially outer side and leaving no free spaces there. The additional mass 76 is arranged outside of the force flow and accordingly only carries out its function of increasing the mass moment of inertia of the secondary side of the phase shifter 42. The material contributes neither to strength nor to the stiffness of the construction, but rather also causes an additional stress on the surrounding parts. The linking of the input ring gear 68 with a separate connection to the cover plate 52 located radially inside of the outer damper 57 limits the diameter of the toothing pitch circle and accordingly also results in the mass of the ring gear 68 being arranged on a radially smaller radius so that it does not generate as much mass inertia as it would on a larger radius. As solution, approaches are presented in the following for optimized configuration of the corresponding component parts in which, in particular, the arrangement of mass is optimized with respect to mass moment of inertia and transmission of force.

When rotational irregularities are reduced by power splitting, the mass moment of inertia on the output side of the radially outer spring accumulator 57 is a critical quantity with respect to function and has a decisive influence not only on the quality of the phase shifting but also on the decoupling of vibration components of the torque branch 18-1 guided via the phase shifter 42. In general, better decoupling can be achieved with high mass moments of inertia and spring sets and gear ratios adapted thereto than with low mass moments of inertia. However, this is at odds with the requirements for the lowest possible weight of the converter in its entirety and low total mass moment of inertia for reasons of vehicle dynamics. Accordingly, it is necessary to provide a maximum permissible mass moment of inertia with the least possible mass at the output of the phase shifter 42. For purposes of a modular construction, the option of varying the mass moment of inertia by adding or omitting elements can also be provided. In a construction according to FIG. 2a-c, these requirements are already taken into account in that already existing masses or mass moments of inertia such as that of the turbine 75 are connected to the output side of the phase shifter 42 and in that a supplementary additional mass 76, which can vary in size has been provided, for example, in the form of a plate and/or a mass ring. However, optimal utilization of space in which as much mass as possible is arranged on a large radius is permitted only conditionally by the conventional manner of fabrication from bent sheet metal parts which are mostly riveted together. Further, there is no force flow through the additional mass 76 which is connected as separate component part so that the very massively constructed additional mass 76 does not contribute to the strength or stiffening of the assembly.

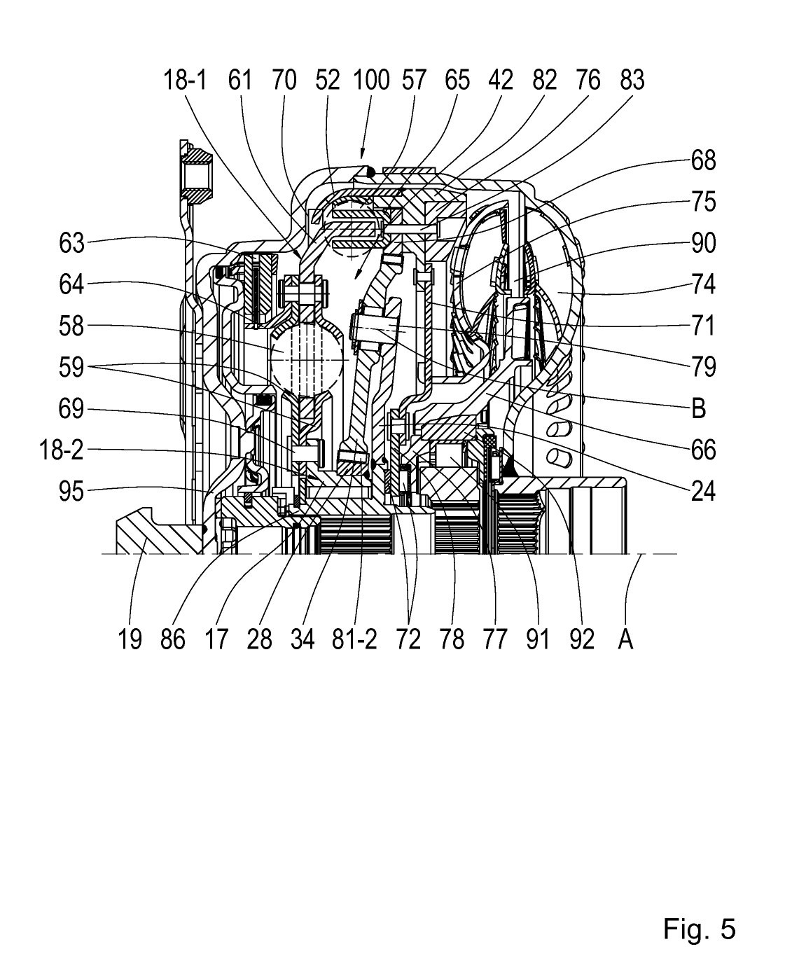

FIG. 5 shows a further embodiment that differs from the embodiments described thus far particularly through a more compact construction of the secondary side of the phase shifter arrangement 42 or outer spring set 57. Further, the input ring gear 68 is linked to the secondary side of the outer damper 57 radially outside of an inner diameter of the outer damper 57, which results in a higher mass moment of inertia.

As has already been mentioned in the introductory part referring to FIGS. 2a-c, the first torque transmission path 18-1 can comprise a phase shifter arrangement 42 for generating a phase shift of rotational irregularities conducted via the first torque transmission path 18-1 with respect to rotational irregularities guided via the second torque transmission path 18-2. The manner of functioning of the phase shifter arrangement 42 has already been described in detail and need not be described again here. The phase shifter arrangement 42 has a radially outwardly located (outer) spring set 57. This outer spring set 57 couples a primary side formed by the hub disk 61 to a secondary side formed by the intermediate element 52. The intermediate element 52, which is coupled to a stop element 65, is connected to a secondary-side mass base body 82, for example by a weld joint. In order to increase a mass moment of inertia of the integrally formed mass base body 82, which can have a positive effect on the phase shifting, it is non-rotationally connected to a turbine 75 of an axially adjacently arranged torque converter via a support 71, which is coupled to the mass base body 82, extends from the radially outer side to the radially inner side and is connected to the mass base body 82 so as to be fixed with respect to rotation relative to it. In addition, additional masses 76, which increase the mass moment of inertia of the base body 82 and can accordingly have a positive effect on the phase shifting can also be provided in this case.

A majority of the mass of the subassembly downstream of the spring set 57 is formed by the one-piece mass base body 82 which can be produced by massive forming or casting. The mass base body 82 forms a connecting link between the guide plate or intermediate element 52 of the outer spring set 57 which can be constructed in a simpler manner in this case than in the original construction according to FIGS. 2a-c which, based on the modular construction principle, allows the mass moment of inertia of the subassembly to be adapted to different applications. In the section shown in FIG. 5, an axially extending rivet 83 connects component parts 65, 68, 82 and 76 radially outside of an inner diameter of the outer damper 57. There can be further connection points of this kind at further locations along the circumference of the outer spring set 57 where no stop element 65 is located and only the other parts are connected to one another in a corresponding manner at these connection points. A torsion stop 70 which limits a twist angle of the outer spring set 57 and accordingly protects the spring set 57 against block stress can preferably be provided between the input-side hub disk 61 and the output-side guide plate or intermediate element 52 and can be located on the engine side (or upstream with respect to the torque flow) of the spring set 57. In this regard, corresponding engine-side tabs can be formed, e.g., at the two components 61 and 52, which tabs cover the same circumference and therefore bump against one another after a defined twist angle is reached.

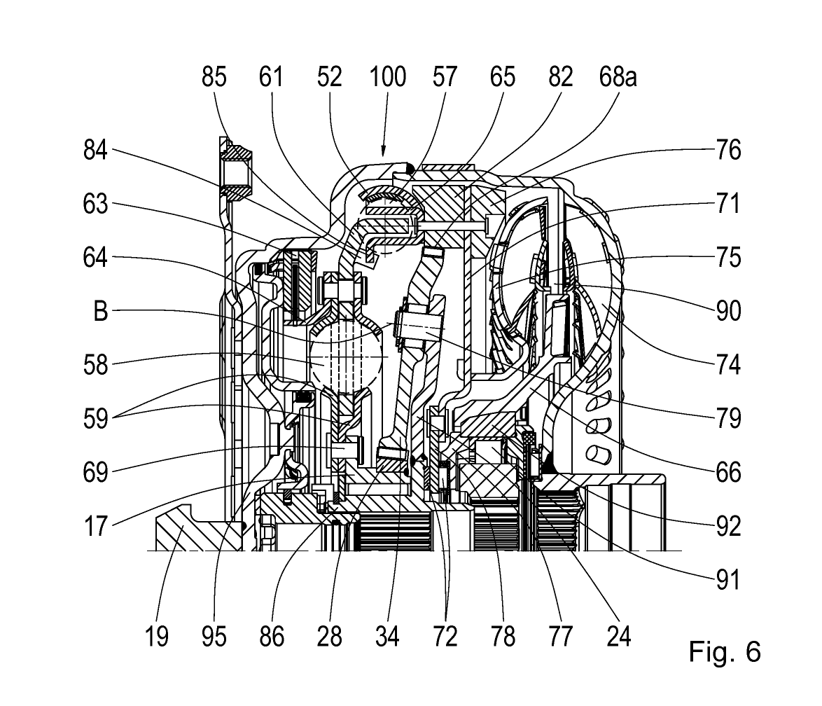

FIG. 6 shows a further optional modification of the construction in which a ring gear toothing 68a is integrated into the one-piece mass base body 82. An inner diameter of the mass base body 82 and, therefore, also of the ring gear toothing 68a can be greater than an inner diameter of the outer spring set 57, which results in a higher mass moment of inertia. The guide plate 52 of the outer spring set 57 can be configured in such a way that it is pulled radially in direction of rotational axis A on the transmission side of the outer spring set 57 adjacent to the latter and between the latter and the mass base body 82 and contacts an axial plane surface of the axially adjacent mass base body 82 by a portion oriented radially inward. Corresponding cutouts can be provided at the locations along its circumference at which the stop elements 65 are positioned so as to enable a nesting with the stop elements 65 in circumferential direction. The support plate 71, which is arranged axially between mass base body 82 and an additional mass 76, can be pulled in axial direction in direction of the turbine 75 until it is possible to connect, e.g., by riveting, the support plate 71 to the mass base body 82, additional mass 76 and—depending on the position on the circumference—either to the guide plate 59 or the stop element 65 on a pitch circle with rivets axially penetrating all of the above-mentioned components.

FIG. 6 also shows an alternative configuration of the stop 65 for protecting the outer spring set 57, in which bent-out, cooperating tabs 84 and 85 of component parts 61 and 65 radially inside of the outer spring set 57 limit a twist angle. A bent-out tab 84 of the primary-side hub disk 61 faces substantially in direction of the planet gear 34. A tab 85 of the stop element 65 corresponding to it is formed by a radially inwardly directed end portion of the stop element 65 extending axially over the latter. Of course, other specific configurations are possible.

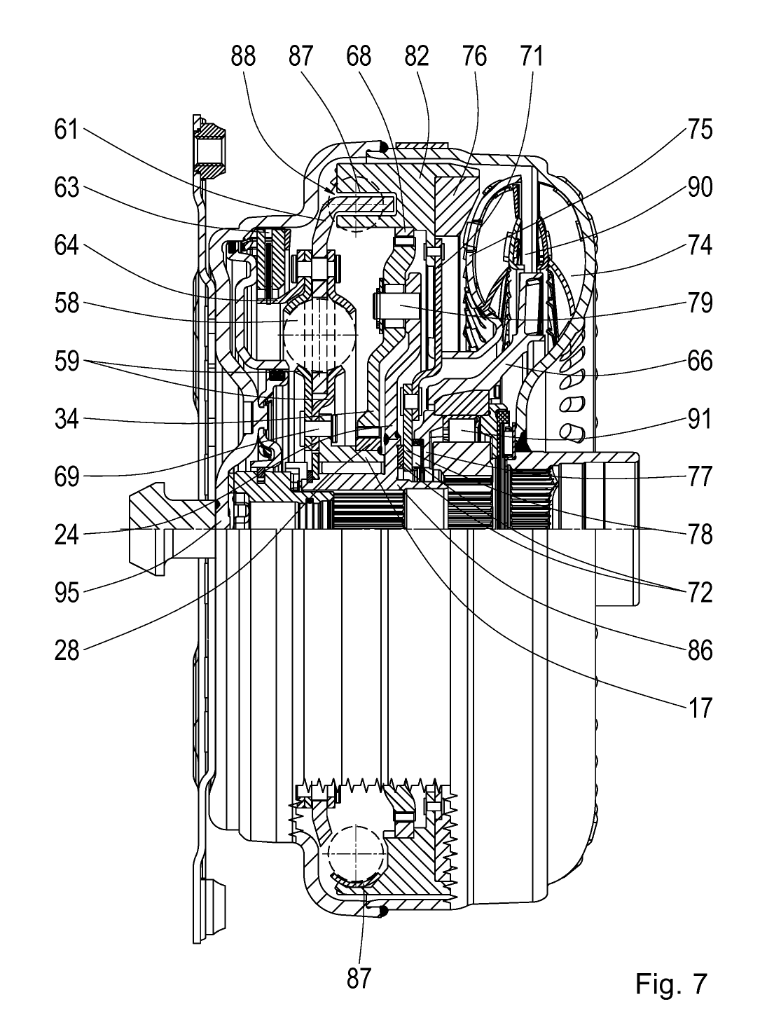

FIG. 7 shows a further optional modification of the construction in which an even more extensive integration of functions and component parts has again been realized so as to facilitate utilization of installation space, assembly and production. Although the second rotational axis B is not substantially tilted, or not at all tilted, with respect to the first rotational axis A in FIG. 7, the construction shown in FIG. 7 can easily be combined with embodiment examples in which the first rotational axis A and second rotational axis B run obliquely with respect to one another. According to FIG. 7, the one-piece mass base body 82 is again preferably produced as massive-formed part. Compared to other embodiment forms, the mass base body 82 in this case virtually by itself forms the secondary side of the outer spring set 57 and takes over the functions of the intermediate element 52 and stop element 65. The mass base body 82 is shaped such that it can ensure a radial support of the outer spring set 57 and can also have studs which project into the spring channel and provide a stop for the springs in circumferential direction thereof. According to one embodiment, the mass base body 82 can have studs that project into the spring channel of the spring arrangement 57 and which serve as stops for springs of the spring arrangement 57 in circumferential direction. As is shown in the lower section in FIG. 7, the spring itself can run in a sliding path plate 87 which can be arranged radially inside of an axial lip of the mass base body 82 facing in direction of the engine. Accordingly, the base body 82 can be constructed in a simpler manner because a spherical contour is not needed. In order to hold the sliding path plate 87 such that it cannot slip out axially on the engine side, the axial lip of the base body 82 can be bent radially inward at a plurality of locations along the circumference away from the studs for the spring stop, as is shown in the lower section in FIG. 7.

In this case, the ring gear 68 can again be constructed as a separate component part and can be pressed with the mass base body 82; an additional positive engagement, for example by means of a spline, can determine the position and prevent rotation. An inner diameter of the mass base body 82 and, therefore, also of the ring gear toothing 68a can again be larger than an inner diameter of the outer spring set 57. The spline is one possible form of a shaft-hub connection. It is a multiple driver connection in which the torque is transmitted by the tooth flanks. The shaft is externally toothed and the hub is internally toothed. Of course, it is also conceivable to use other joining processes and connecting processes between the mass base body 82 and ring gear 68 or to integrate as an individual component part.

According the embodiment in FIG. 7, a torsion stop for blocking protection of the outer spring set 57 can be provided in such a way that fingers of the primary-side hub disk 61 which extend in between the individual springs of the outer spring set 57 in order to control it penetrate by their tips into an axial groove 88 in the base body 82 which can correspondingly limit the twisting range through interruptions in circumferential direction.

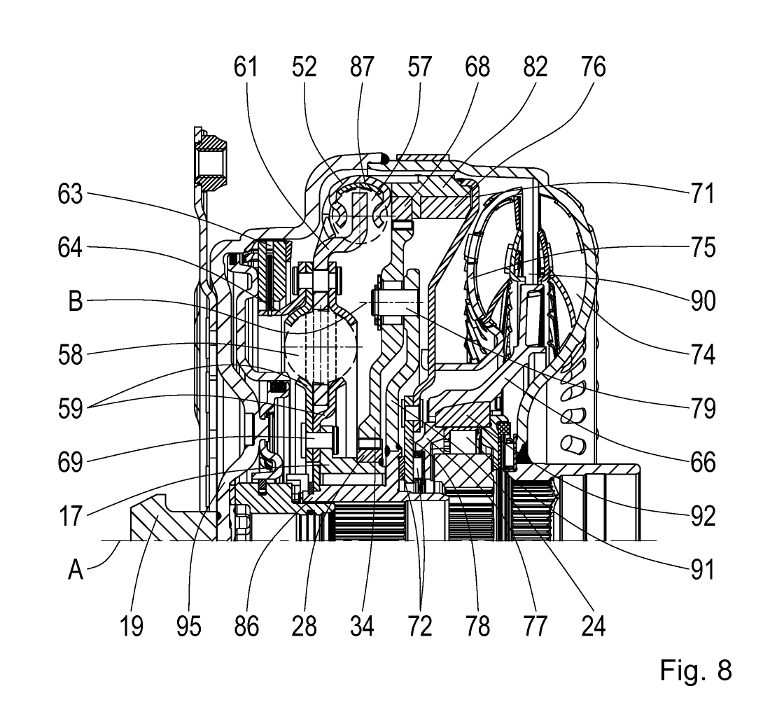

FIG. 8 shows a further embodiment form which differs from the embodiment examples described above in that the primary-side hub disk 61 which is coupled on the input side to the output 64 of the converter lockup clutch 62 and extends from the inner spring set 58 radially outward in direction of the outer spring set 57 engages in the outer spring set 57 of the outer torsional vibration damper from the radially inner side to the radial outer side. The guide plate or intermediate element 52 of the outer spring set 57 can then be shaped in such a way that it guides the springs radially and—on the engine side—axially. According to the embodiment shown in FIG. 8, the guide plate 59 has a substantially omega-shaped cross section. Additionally, in order to provide a stop for the springs in circumferential direction, segments of the guide plate 52 can be bent radially inward into the spring channel at a plurality of locations in circumferential direction (for example, between two springs or series-connected spring sets). Accordingly, a separate stop element is not needed. As is shown, a connection to the mass base body 82 can be carried out, for example, by pressing on and/or welding. A torsion stop can be carried out analogous to the embodiment form according to FIG. 6 by means of mutually corresponding projections at the hub disk 61 and guide plate 52. The mass base body 82 again forms the connecting link between the secondary-side components. In addition to the connection to the guide plate 52, which has already been described, the ring gear 68 and possibly an additional mass 76 can be linked through a joining process, for example, pressing and/or pinning, to the mass base body 82. The inner diameter of the mass base body 82 and, therefore, also the ring gear toothing can be appreciably larger than an inner diameter of the outer spring set 57. The support part 71 which forms the connection to the turbine 75 and axial bearing location 72 can likewise be fastened to the base body 82, for example, by pressing and/or welding, as is shown in FIG. 8.

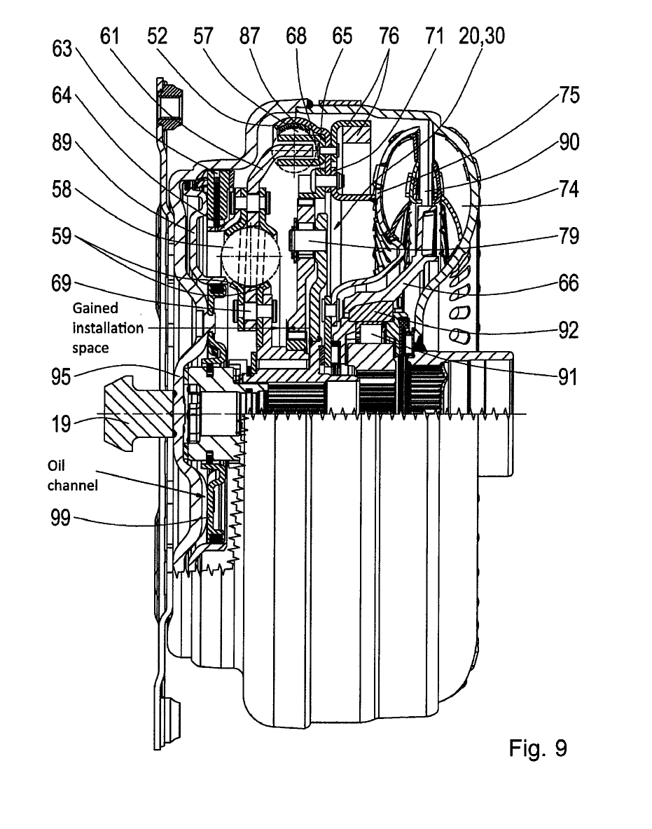

FIGS. 9 and 10 show further embodiment forms of assemblies with torsional vibration damping arrangements which are coupled to a torque converter 90. Although the two rotational axes A, B depicted in FIGS. 9 and 10 are not tilted, or not significantly tilted, with respect to one another, the constructions according to FIGS. 9 and 10 can be combined without difficulty with embodiment examples in which the two axes A, B extend obliquely relative to one another.

With the goal of freeing up axial installation space for the teeth of the coupling gear unit 20, 30, various steps can also be undertaken to shift the inner spring set 58 farther in the direction of the engine or crankshaft 19 particularly so as to make better use of the free space radially inside of or underneath the converter clutch 62. FIGS. 9 and 10 show variants of this kind which can easily be combined with other embodiment examples.

FIG. 9 shows a modification of the control of the converter clutch 62. A channel for a fluid (e.g., oil), which presses an actuating piston 89 against the clutch 62 in order to actuate the clutch 62 is typically formed by beads in the piston support 99. By “beads” is meant manually or mechanically produced gutter-shaped depressions. According to one embodiment, however, the fluid channel can be relocated to the housing 95 so that the piston support 89 can be flatter axially and therefore narrower by an amount corresponding to the height of the channel. Accordingly, the inner spring set 58 can be shifted in direction of the engine resulting in the gained installation space shown in FIG. 9 for the gear unit 20. In addition, the rivet 69 can be shifted to a radius outside of the sun gear addendum circle to facilitate assembly and the radially inwardly directed guide plate 59 of the inner spring set 58 and, in some cases, the hub disk 61 can be adapted for this purpose.

FIG. 10 shows a further optional modification of the converter clutch 62 in which, in addition to the shifting of the oil channel into the housing 95 mentioned above, the clutch 62 itself is offset farther radially outward so that there is no radial overlap between the converter clutch 62 and inner spring set 58 or guide plates 59 thereof. As a result of the additional installation space gained in this way, a contact point between the actuating piston 89 and piston support 99 can likewise be shifted radially outward (approximately to the radial level of the inner spring set 58) and axially in direction of the engine or crankshaft 19. Accordingly, the inner spring set 58 can then also be shifted axially in direction of the engine and can open up the additional installation space shown in FIG. 10 for the coupling gear unit 20, 30. As a further advantage in the arrangement according to FIG. 10, the linking of the converter clutch 62 to the spring accumulator, i.e., the clutch output 64, can be carried out through appropriate configuration of the spring accumulator cover plate 59 itself. Referring to FIG. 10, the converter clutch output 64 and cover plate 59-1 are formed as an individual component part which can be coupled to the hub disk 61 so as to be fixed with respect to rotation relative to it by means of an axial pin 98.

A further step which can provide even more axial installation space for the coupling gear unit 20 and which will be described further in the following consists in relocating the axial bearing location 72 of the freewheel and of the components on the secondary side of the phase shifter 42.

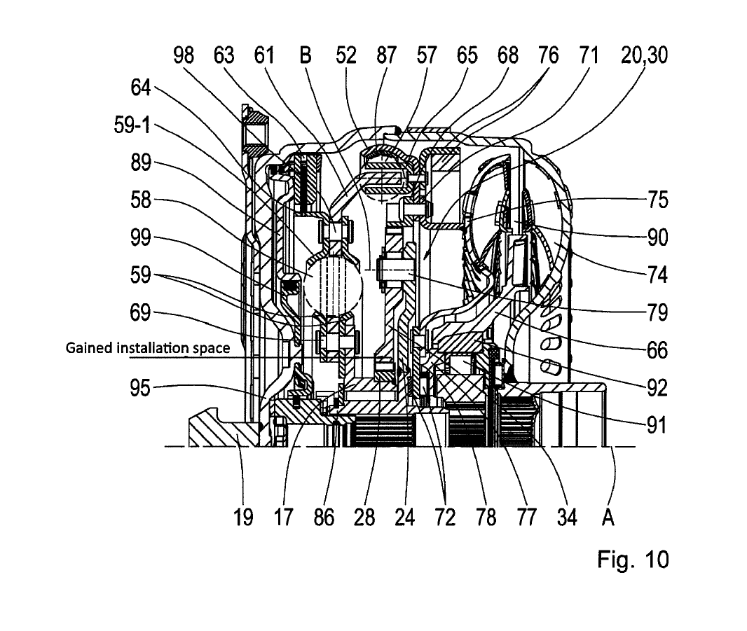

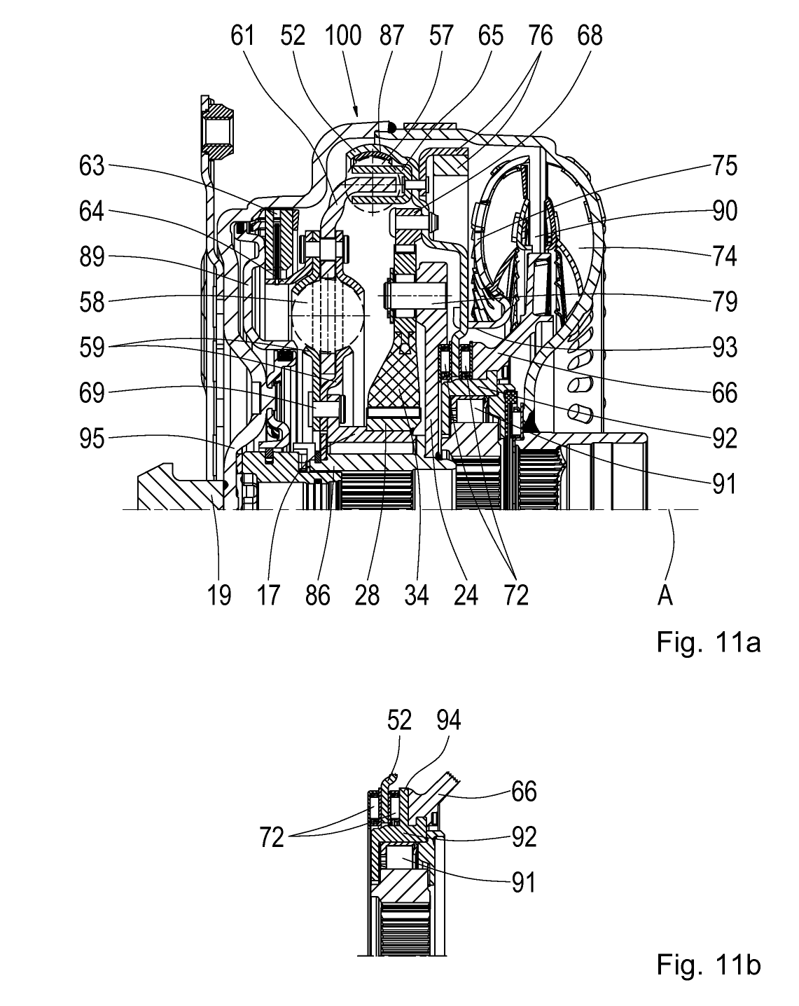

In this regard, FIG. 11a shows a start-up element for a motor vehicle with a torque converter 90 that can be operated via a drive member and a housing arrangement 95 and which comprises a stator 66 which is rotatable around a rotational axis A and which has a freewheel having a radial bearing 91, 92. The start-up element further comprises a subassembly which is arranged axially outside of the torque converter 90 in the form of a torsional vibration damping arrangement which has already been described in detail. Alternatively or additionally, the subassembly can also have components other than those depicted. While the two rotational axes A, B depicted in FIG. 11a are not tilted, or not significantly tilted, with respect to one another, the construction according to FIG. 11a can easily be combined with embodiment examples of the present invention in which the two axes A, B extend obliquely relative to one another.

As opposed to the embodiment forms described previously, the start-up element shown in FIG. 11a is characterized in that an axial bearing support or axial bearing location 72 of the freewheel by which the freewheel or stator 66 is supported axially toward the torsional vibration damping arrangement is arranged radially outside of the radial bearing 91, 92 of the freewheel. In particular, the axial bearing 72 of the freewheel can be arranged radially outside of an outer ring 92 of the radial bearing by which the stator 66 is supported radially toward the rotational axis A and forms the freewheel. By relocating the axial bearing location 72 from a position axially next to or adjacent to the radial bearing 91, 92 of the freewheel to a position radially above or outside of the radial bearing 91, 92 of the freewheel, the axial installation space required by the axial bearing 72 can be saved and freed up.

As in the initial construction according to FIGS. 2a-c, the axial bearing location 72 which has been shifted radially outward can comprise two axial bearings which are located in the force flow between the outer ring 92 of the freewheel or stator 66 on one hand and the planet gear carrier 24 or an output flange 86 to the transmission input shaft on the other hand, and component parts of the secondary side of the phase shifter 42, e.g., the cover plate 52, ring gear 68 and, possibly the additional mass 76 and turbine 75, are axially supported between these two axial bearings. However, one difference consists in that the axial bearing location 72 is not located axially next to the freewheel but rather radially outside of the freewheel and at least partially radially outside of the same axial plane. In other words, the axial bearing support 72 of the freewheel can at least partially axially overlap with the radial bearing 91, 92 of the freewheel. As a result of this nesting, the installation space next to the freewheel on the engine side can be freed and utilized, for example, to implement a substantially wider sun gear 28 and/or correspondingly wider tooth segments of a corresponding planet 34 (see FIG. 11a) or to make the converter 90 narrower overall.

According to embodiment examples, a linking of the turbine 75 to the secondary side of the phase shifter 42 can be realized in such a way that sheet-metal tabs 93 project out at the radially inwardly located base of the turbine 75, these sheet-metal tabs 93 being guided through corresponding windows in the cover plate 52 which is pulled radially inward up to the axial bearing location 72 and are then bent down or rolled such that the two parts 52, 75 are connected to one another by a positive engagement. In other words, the torque converter 90 formed by the turbine 75, stator 66 and impeller 74 can be arranged axially next to the torsional vibration damping arrangement, and the turbine 75 has at least one tab 93 which engages axially in an output-side element 52 of the torsional vibration damping arrangement so that the turbine 75 and the torsional vibration damping arrangement, or the output region thereof, are coupled to one another so as to be fixed with respect to rotation around the rotational axis A.

The following advantages result from the embodiment form in Figure lla:
The appreciable increase in the available axial installation space of the toothing at/to the sun gear 28 allows less sturdy materials to be used, e.g., plastic.
Due to the fact that the axial bearing location 72 is arranged on a larger radial diameter, the distance between the bearing 72 and the masses to be supported is shorter; accordingly, the linking of these parts, which is realized in this case by means of the guide plate 52 of the outer spring set 57 which is pulled down radially into the bearing 72, is shorter and therefore stiffer and more precise.
The planet gear carrier 24 or another output element can be as stiff as possible for optimal functioning of the power split; configuring this for strength to absorb axial bearing forces also benefits its function for reducing rotational irregularities; the planet gear carrier 24 itself is additionally stiffened by the additional supporting point by means of the bearing 72.
The free installation space above the freewheel is brought about by an oval-shaped configuration of the hydrodynamic circuit and a higher axial offset between the stator blades and freewheel and serves so far for receiving the masses of a speed-adaptive mass damper; however, with reduction of rotational irregularities through power splitting, this installation space is not needed in the radially inner region and can be utilized for relocating the bearing.
The pressure disk 77 can be dispensed with; instead, as is shown, the outer ring 92 of the freewheel can be constructed in a corresponding manner such that it provides a covering toward the side (in direction of the planet gear carrier 24) and serves as axial stop for the inner ring; accordingly, the outer ring 92 can have a shelf which is directed radially inward and covers the radial bearing of the freewheel in direction of the axially adjacent torsional vibration damping arrangement and forms an axial stop for an inner ring of the radial bearing.

According to the embodiment form in FIG. 11a, the axial bearing 72 is arranged radially outside of the radial bearing 91, 92 and axially between an output-side component 24 of the subassembly (torsional vibration damping arrangement) and a radially extending plane surface of the stator 66. In other words, an axial plane surface of the stator 66 provides a running surface for rolling elements of the axial bearing 72. Also, a further counter-running surface is provided by a plane surface of the planet gear carrier 24. In addition, there is located between the rolling elements a radially inner end of the intermediate element 52 on which the rolling elements can roll and which therefore acts as a kind of bearing disk.

FIG. 11b shows a further embodiment in which the bearing location 72 can be configured in a different way. In this case, a radially outwardly directed side surface 94 at the hardened outer ring 92 of the freewheel directly forms a race of one of the two axial bearings 72. Accordingly, the outer ring 92 of the radial bearing of the freewheel can have between its axial ends a shelf 94 which is directed radially outward and which is formed as a running surface for rolling elements of the axial bearing 72 of the freewheel. Accordingly, the shelf 94 may be arranged between the rolling elements and the axial plane surface of the stator 66. As an alternative to the depicted axial needle bearing, other axial rolling element bearings or axial-radial rolling element bearings or plain bearings are also possible.

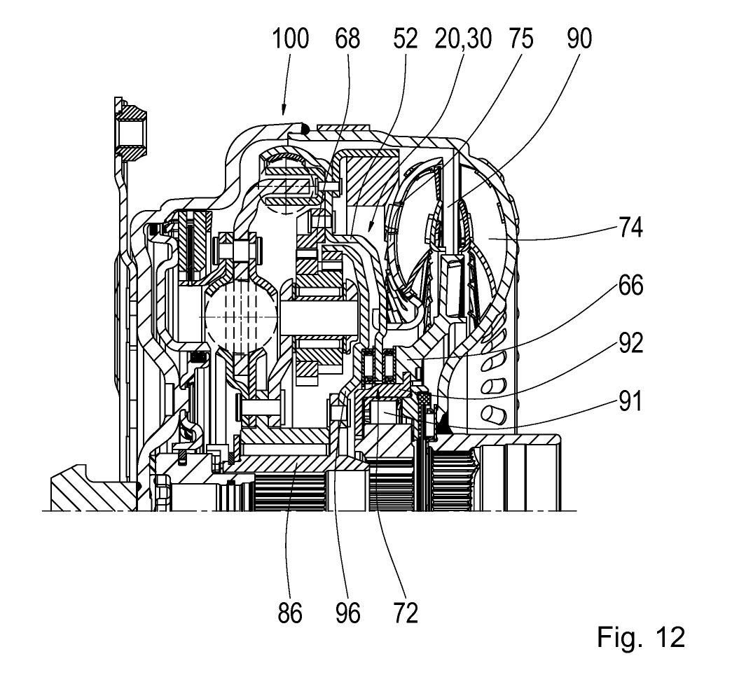

FIG. 12 shows a further possibility for utilizing the installation space gained by relocating the bearing location 72. As a result of the gained installation space, an epicyclic coupling gear set 20 with two ring gears 68, 96, an input ring gear 68 and an output ring gear 96 can also be connected in spite of the larger axial space requirement without enlarging the outer dimensions of the converter 90. As can be seen from FIG. 12, the stator 66 in this embodiment form is supported via the axial bearing 72 located radially outside of the freewheel 91, 92 toward an output ring gear carrier 96 coupled to the output flange 86 to the transmission input shaft. Consequently, according to embodiment examples, the stator 66 can be supported via the axial bearing 72 toward planet gear carriers and/or output ring gear carriers 52, 96 extending radially outward from rotational axis A. In this respect, the radially outwardly extending planet carrier 24 and/or output ring gear carrier 96 can form a running surface for rolling elements of the axial bearing 72 of the freewheel.

When the turbine 75 of the converter 90 is connected to the output side of the phase shifter 42 in order to utilize the mass moment of inertia thereof for the phase shifting, the torque flow is transmitted via the power splitting to the transmission input shaft also when the converter clutch is open, i.e., during the actual converter operation. The torque introduced into the ring gear 68 via the turbine 75 brings about a torque in the same direction on the planet gear 34 and an oppositely directed torque on the sun gear 28. Due to the oppositely directed torques on the ring gear and sun gear, these two parts rotate opposite one another and the spring set 57, 58 between them is tensioned until a torque equilibrium is reached between the torsional vibration damper and the transmitted torque or until the torsion stop of the vibration damper is reached. From this point onward, the gear unit 30 is blocked and the torque of the turbine 75 is transmitted via the planet gear carrier 24 to the output flange 86 to the transmission input shaft. In this regard, the following problems arise:
The dynamics of the drive are impaired in that the spring accumulators 57, 58 must be tensioned before force is transmitted to the gear unit.
Since the force is introduced directly to the ring gear 68, the full input torque is now applied there rather than only part of the torque; but the engine torque has now also been increased by the converter increase; even if the spring set 57, 58 is protected against overloading due to excessively high torque by corresponding stops, the stress on the teeth is increased many times over.

This set of problems can be solved in that elements are provided between the output region 52 of the torsional vibration damping arrangement and the output region 24 of the coupling arrangement 20, 30 for limiting a relative rotation between the output region 52 of the torsional vibration damping arrangement and the output region 24 of the coupling arrangement 20,30 around the rotational axis A. For example, referring to FIG. 12, an additional stop can be provided between the output side 52 of the spring accumulator to which the turbine is attached and the output 24, 86 to the transmission, preferably the planet gear carrier 24. As a result, the force flow via the power splitting gear unit 30 and the phase shifter 42 can be bridged.

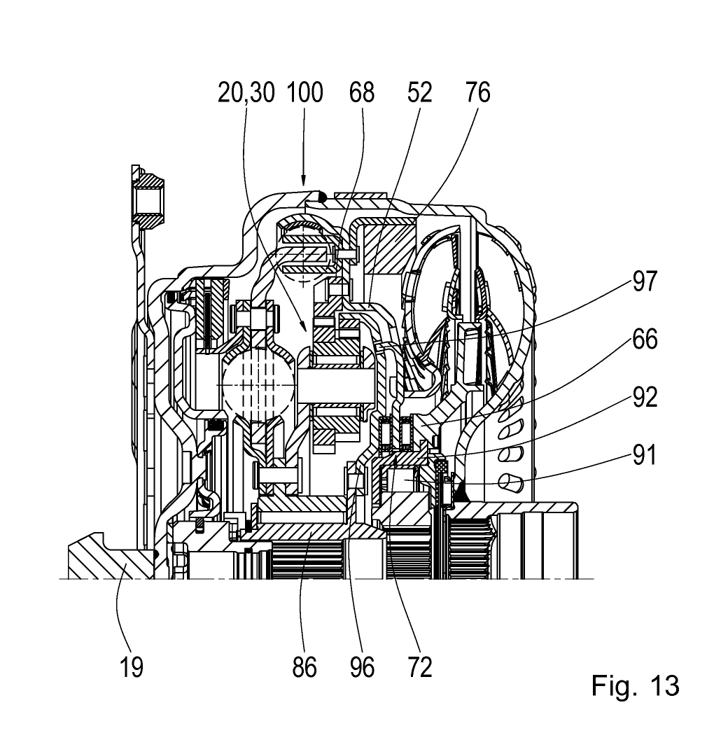

FIG. 13 shows a different implementation in combination with a coupling gear unit connected to the output ring gear instead of the planet gear (carrier). The above-mentioned stop can be implemented, for example, in such a way that a tab 97 projects from the guide plate 52 and can engage axially in an elongated hole in the support 96 of the output ring gear, which elongated hole corresponds to the tab 97. Portions of the output region 52 of the torsional vibration damping arrangement or guide plate 52 and of the output region of the coupling arrangement 20, 30 or output ring gear carrier 96 which run in radial direction overlap in the region of the stop or tab 97. It should be stressed that the above-described means for limiting a relative rotation between the output region 52 of the torsional vibration damping arrangement and the output region of the coupling arrangement 20, 30 around the rotational axis A can be used regardless of the position of the axial bearing 72 so that the stop can also be combined with other embodiment forms which have been mentioned above.

In summary, different features, which can also be combined, have been presented for solving the fundamental problems arising in reducing rotational irregularities by power splitting, particularly as applied in torque converters.

The features disclosed in the description above, the following claims and the attached figures may be of importance and implemented both individually and in any combination for the realization of an exemplary embodiment in its various forms.

Although some aspects have been described in connection with a device, it should be understood that these aspects also represent a description of the corresponding method, so that a block or a component of a device shall also be understood as a corresponding method step or as a feature of a method step. Analogous to that, aspects which were described in connection with or as a method step also represent a description of a corresponding block or detail or feature of a corresponding device.

The embodiment examples described above represent only an illustration of the principles of the present invention. It will be appreciated that modifications and variations of the arrangements and particulars described herein will be apparent to other persons skilled in the art. Therefore, it is intended that the invention be limited only by the scope of protection of the following patent claims and not by the specific details that were presented herein with the description and the explanation of the embodiment examples.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-15. (canceled)

16. A torsional vibration damping arrangement for a drivetrain of a vehicle, comprising:
an input region configured to be driven in rotation around a first rotational axis (A);
an output region;
a first torque transmission path proceeding from the input region to the output region;
a second torque transmission path proceeding from the input region to the output region; and
a coupling arrangement connected to the output region configured to superpose respective torques guided via the torque transmission paths, comprising a planetary gear set with a planet gear that is rotatable around a second rotational axis (B),
wherein the first rotational axis (A) and the second rotational axis (B) run obliquely with respect to one another.

17. The torsional vibration damping arrangement according to claim 16, wherein the first rotational axis (A) and second rotational axis (B) run obliquely with respect to one another in a plane defined by the first and second rotational axes (A; B).

18. The torsional vibration damping arrangement according to claim 16, wherein a rotational axis of an input ring gear of the planetary gear set located in the first torque transmission path and configured to mesh with the planet gear and a rotational axis of a sun gear of the planetary gear set located in the second torque transmission path and configured to mesh with the planet gear run parallel to the first rotational axis (A) respectively.

19. The torsional vibration damping arrangement according to claim 16, wherein the planet gear has a first planet gear part with a first toothing diameter and a second planet gear part with a second toothing diameter that differs from the first toothing diameter.

20. The torsional vibration damping arrangement according to claim 19, wherein an input ring gear of the planetary gear set located in the first torque transmission path meshingly engages with the first planet gear part, and a sun gear of the planetary gear set located in the second torque transmission path meshingly engages with the second planet gear part.

21. The torsional vibration damping arrangement according to claim 20, wherein the planet gear parts are arranged so as to be axially offset with respect to one another in direction of the second rotational axis (B).

22. The torsional vibration damping arrangement according to claim 21, wherein the first planet gear part is formed by a first circle segment of the planet gear with the first toothing diameter and the second planet gear part is formed by a second circle segment of the planet gear with the second toothing diameter.

23. The torsional vibration damping arrangement according to claim 16, wherein the first torque transmission path includes a phase shifter arrangement configured to generate a phase shift of rotational irregularities guided via the first torque transmission path with respect to rotational irregularities guided via the second torque transmission path.

24. The torsional vibration damping arrangement according to claim 23,
wherein the phase shifter arrangement has a primary side and a secondary side that is coupled to the primary side through a spring arrangement,
wherein the secondary side is formed by a one-piece mass base body configured to provide a mass moment of inertia, and
wherein a ring gear toothing is formed in the one-piece mass base body for meshing with the planet gear.

25. The torsional vibration damping arrangement according to claim 24, wherein the spring arrangement is radially supported at the one-piece mass base body.

26. The torsional vibration damping arrangement according to claim 24, wherein the one-piece mass base body has studs that protrude into a spring channel of the spring arrangement and function as stops for a spring of the spring arrangement in circumferential direction.

27. The torsional vibration damping arrangement according to claim 24, wherein a hub disk of the primary side engages in the spring arrangement of the phase shifter arrangement from the radially inner side to the radially outer side.

28. The torsional vibration damping arrangement according to claim 16, wherein the torsional vibration damping arrangement is connected between a converter lockup clutch and a hydrodynamic torque converter.

29. The torsional vibration damping arrangement according to claim 28,
wherein the hydrodynamic torque converter is arranged axially outside of the torsional vibration damping arrangement, and the torsional vibration damping arrangement is coupled to a turbine of the hydrodynamic torque converter that has a stator with a freewheel having radial bearing,
wherein an axial bearing of the freewheel by which the freewheel is axially supported toward the torsional vibration damping arrangement is arranged radially outside of the radial bearing of the freewheel.

30. A motor vehicle having a torsional vibration damping arrangement comprising:
an input region configured to be driven in rotation around a first rotational axis (A);
an output region;
a first torque transmission path proceeding from the input region to the output region;
a second torque transmission path proceeding from the input region to the output region; and
a coupling arrangement connected to the output region configured to superpose respective torques guided via the torque transmission paths, comprising a planetary gear set with a planet gear that is rotatable around a second rotational axis (B),
wherein the first rotational axis (A) and the second rotational axis (B) run obliquely with respect to one another.

31. The torsional vibration damping arrangement according to claim 25, wherein the one-piece mass base body has studs that protrude into a spring channel of the spring arrangement and function as stops for a spring of the spring arrangement in circumferential direction.
